(19) United States
(12) Patent Application Publication
(10) Pub. No.: US 2008/0102160 A1
(43) Pub. Date: May 1, 2008

(54) Wine-making press

(75) Inventors: Gregory Dixon Snell, San Jose, CA (US); Thomas Lorincz, Hollister, CA (US); Mike Ravkin, Sunnyvale, CA (US); Thurman J. Rodgers, Woodside, CA (US); Richard Phipps, Morgan Hill, CA (US)

Correspondence Address: Gregory D. Snell, 6059 Whitehaven Ct., San Jose, CA, 95138, US

(73) Assignee: PROVINA Incorporated

(21) Appl. No.: 11/588,792

(22) Filed: Oct. 30, 2006

(51) Int. Cl. C12G 1/00

(52) U.S. Cl. 426/15

(57) ABSTRACT

A wine-making pressing and fermenting apparatus that contains a compression-fermentation tank and a press plate moveable relative to the bottom of the tank due to engagement of a lead screw with a nut. According to one embodiment, the nut is fixed to the press tube that extends downward from the tank cover and engages the lead screw threaded into the nut from below and driven into rotation by the motor located under the tank in the tank supporting structure. According to another embodiment, the nut is fixed to the tank tube that extends upward from the tank bottom and engages the lead screw threaded into the nut from above and driven into rotation by the motor located over the tank and supported by the tank cover. The press plate has a plurality of through openings for squeezing out the grape juice.

### BACKGROUND OF THE INVENTION

1. Field of the Invention

This invention relates generally to wine making, and more particularly to a novel wine making press and process. More specifically, the invention relates to a wine-making press the construction of which makes it applicable for domestic household as well as for commercial production.

2. Description of the Background Art

The art of wine making has traditionally been a lengthy and complicated process. Wine making processes include crushing of wine grapes, pressing the grapes for separating the grape juice/wine from the grape solids, and fermenting the wine-making ingredients. The primary operations used to produce wine result in a lengthy production process requiring transfer of the wine making ingredients between many machines and tanks. The repeated transfer of ingredients and the specialized machines involved make wine production a costly operation in terms of both labor and equipment.

Wine making is a highly specialized art that varies between producers. However, the above-mentioned operations are fairly consistent throughout the wine making field. In the first step of conventional wine production, grapes are loaded into a crusher. The crusher crushes the grapes producing a mixture of grape juice and solids (e.g. grape skins). The crusher is a large perforated cylinder, housing a series of paddles that rotate generally between 600-1200 rpm. The grapes are crushed and both the solid and liquid portions of the grapes exit the crusher. Because of their specialized nature, crushing machines are generally expensive to purchase and maintain.

In the case of white wines, following the crushing operation the crushed grapes must be moved to a pressing machine to separate the liquids and solids. Depending on the application, grape juice can be extracted from the liquid-solid mixture using any combination of the following processes. First, the “free run juice” can be extracted from the liquid-solid mixture by straining. To accomplish this, the crushed grapes are fed into containers having a screened bottom and/or sides, which allows grape juice to exit while retaining the solids in the screened containers. Alternately, the crushed grapes are put into a horizontal “basket press” and the crushed grapes are pressed from both sides. The juice exits the basket press through perforations in the side walls of the press. In another process, a continuous screw press may be used to press the crushed grapes. Yet another type of press utilizes a perforated cylindrical portion that rotates, and an inflatable bladder placed within the cylinder along with the crushed grapes. The bladder is inflated and the crushed grapes are pressed against the rotating cylinder walls forcing the grape juice out of the press.

Fermentation is common to all wine making processes. During fermentation, the grape juice (optionally, the entire grapes) is transferred to a fermentation tank for a number of weeks. When fermentation is done before the pressing operation (typically with red wines) the grape skins float on top of the free run juice/wine. These grape skins must be attended to and stirred several times a day to permit the fermenting grape juice to breathe and remain at an appropriate temperature. After primary fermentation, the wine is pressed as required.

Many of the machines used to make wine are expensive and difficult to maintain. Straining is an inexpensive alternative to the other pressing devices (e.g., the continuous screw press, the bladder press, the basket press, etc.), however the strainer would often clog and require constant attention from workers. Additionally, the present methods employed to produce wine require transferring the crushed grapes between many different machines and tanks, resulting in a high cost of labor and increased chance of contamination.

What is needed, therefore, is an apparatus and method that reduces the variety of equipment required to make wine. What is also needed is an apparatus and method that reduces the number of times that the wine making ingredients must be transferred between various machines and or tanks. What is also needed is an apparatus and method that cost-effectively simplifies wine production.

For example, Spanish Patent ES2099681 issued in 1997 to Miguel Pena Contreras discloses a process for the preparation of wine, which comprises a multiple-stage process with transfer of the product between the separate containers. The apparatus contains a hopper into which grapes are discharged for subsequent stem removal and pressing. The must is then delivered to a fermentation tank. The process is characterized by the fact that the that the tank which contains the grape skins wholly submerged in must and wine is provided, establishing a reciprocal continuous flow between the skin tank and the fermentation tank through a pressure difference that is used for aiding control of the grape skin.

An attempt to overcome the problems of the prior art and to provide an apparatus for crushing, pressing, and fermenting of the wine making ingredients in a single tank are disclosed in International Patent Application Publication WO 2004037529 published in 2006 (inventors T. Rogers, et al.). The apparatus includes a frame on rollers for mobility and forklift attachment points for placing or replacing the pressing and fermenting tank onto a tank supporting tray. The tray may be engaged with pushing rods of hydraulic cylinders capable of raising the tray with the tank. The lower part of the frame has hollow vertical guiding posts. The upper part of the frame has a cross-like shape and is provided with vertical extensions that extend in the downward direction. These vertical extensions are inserted into the aforementioned hollow guide posts, and the upper frame is fixed relative to the lower frame by lock pins inserted into the aligned openings of the guide posts and of the downward extension. The upper frame supports a press plate that has perforations for passing the liquid squeezed between the lower side of the press plate and the bottom of the tank. Thus lower and upper frame with the press plate are assembled into a rigid structure, while the tray with the tank form a moveable structure that raises the tank relative to the stationary press plate.

Although the wine press described in Patent Application Publication WO 2004037529 allows production of wine by performing all the processes of crushing, pressing, and fermenting of the wine making ingredients in a single tank, arrangement of the driving cylinders in outward radial positions relative to the frame requires an extra floor space. The use of hydraulic or pneumatic means for driving the tank makes the system complicated in structure and in control of the compression mode. The hydraulic and pneumatic drive system are inapplicable and not justifiable for production of wine in small quantities, e.g., in a domestic household. The tank with the grape is inserted into the space between the guide posts from above by means of a crane or the like, and prior to this, the upper frame has to be disconnected and removed from the lower frame and then reinstalled. Such tank loading and unloading operations are time consuming. The raising of the heavy tank consumes energy.

### SUMMARY OF THE INVENTION

It is an object of the present invention to provide a wine press having a construction applicable for domestic and commercial use. It is another object to provide a wine press of the aforementioned type that is simple and compact in construction, simple in maintenance, and allows crushing, pressing, and fermenting of the wine making ingredients in a single tank. It is still another object to provide a wine press of the aforementioned type that uses electric drive instead of a hydraulic or pneumatic drive. It is a further object to provide a wine press that occupies a reduced floor space. It is still another object to provide a wine press that has an efficient cooling/heating system that makes the press suitable for making wines and beverages of different types with a variety of possible fermentation processes. Another object is to provide a press of the aforementioned type equipped with a device for efficient and convenient removal of the grape skin residue.

The wine-making pressing and fermenting apparatus of the invention contains a hollow pedestal portion that supports a compression-fermentation tank and contains the drive mechanism, container with a cooling liquid, a pump, and other appropriate power and control units. The compression-fermentation tank, preferably of a substantially cylindrical shape, is secured to the upper end of the base portion. The upper end of the tank is open, and can be closed by a cover. In a model of the intended for domestic use, the vertical length of the tank may be about 1 meter to 1.20 meter in order for a user to easily load the grape and other components into the tank while standing on the floor or ground where the apparatus is installed. In a model for industrial production, the tank may have any desired height and can be loaded with the use of auxiliary devices such as an overhead hopper, or the like. Welded or removably attached to the central part of the tank bottom is a lower inner vertical tank tube with an open upper end. Inserted into the central opening of this tube is a lead screw that is driven into rotation from an electric motor, preferably a DC motor, which is located inside the hollow pedestal portion and is kinematically connected to the lead screw directly or through an appropriate transmission with a gear ration that may be required to increase of the torque on the lead screw. The diameter of the opening in the aforementioned lower inner vertical tank tube is greater than the outer diameter of the lead screw so that an annular gap is formed between the inner surface of this tube and the outer surface of the lead screw. The lower inner vertical tank tube has on its inner surface a vertical longitudinal key element, which may be, e.g., a male guide key projecting inwardly from the inner surface of the lower tank tube. The upper part of the apparatus, which interacts with the above-described lower part and is removably connected therewith, consists of an upper outer press tube that can be telescopically fitted with its central opening onto the outer surface of the aforementioned lower inner vertical tank tube. Attached to the lower end of the upper press tube is a press plate that has a shape suitable for a sliding fit of the plate inside the compression-fermentation tank and is provided with a plurality of through perforations for passing the juice squeezed out from the grape. The press plate can be welded to the outer surface on the lower end of the upper press tube or can be removably attached thereto. The lower end of the upper press tube is open, while the upper end is closed, e.g., with a threaded fitting that creates a coupling with a press plate tube that extends downward from the aforementioned fitting and is arranged inside the upper press tube concentrically to its inner wall. The lower end of the press plate tube has an outer thread which is engaged with an inner thread made on the upper part of a nut screwed into the lower end of the press plate tube. The aforementioned lead screw, which is located in the lower part of the apparatus, engages an inner thread which is provided in the nut. The outer diameter of the lead screw is smaller than the diameter of the central opening in the press plate tube so that, while engaging the nut, the lead screw can without obstacles penetrate the central opening of the press plate tube. In order to fit the entire press plate's upper tube assembly on the lower tank tube, the inner diameter of the upper outer press tube must be greater than the outer diameter of the lower tank tube, and the inner upper tube inner diameter must be greater than the lead screw outer diameter. In order to prevent rotation of the nut and impart to it only a linear motion due to the engagement with the lead screw, the outer surface of the nut has a key slot for engagement with the aforementioned male guide key of the lower inner vertical tube. The compression-fermentation tank may consist of a main cylindrical portion and outer casing. The casing may have an attractive appearance so that the apparatus acquires the shape of a wine glass having a flat bottom plate, a cylindrical stem that functions as the aforementioned hollow pedestal, and a barrel shaped casing. Located between the main cylindrical part and the casing of the barrel is a heating-cooling unit element in the form of flat hollow belt helically wrapped around the cylindrical main portion for circulation of a cooling/heating medium the temperature of which is controlled by means of a cooling-heating unit, e.g., a Peltier-type unit, that is located in the hollow pedestal. The control console is conveniently installed on the outer side and at the upper end of the casing. The space between the inner casing and the outer casing may preferably include thermal insulation.

The apparatus is further provided with a perforated basket that prior to loading the grape is placed onto the bottom of the tank. The basket has an open upper end and is provided with means for engagement with the projections on the peripheral side of the press plate during the lowering (i.e., pressing) of the press plate for irreversible connection of the basket with the press plate, e.g., by snapping, so that the compressed solids such as grape skin, etc. contained in the basket could be removed from the must contained in the tank together with the press plate when the upper part is disconnected from the lower part of the apparatus after the press plate is raised subsequent to pressing and engagement with the basket.

The device operates as follows. First, the upper part that consists of press plate with the upper tube, nut, and the press plate tube is removed from the apparatus, and the grape, if necessary, with other ingredients is loaded from the above into the tank. The loaded charge should not exceed the level of the open upper end of the inner tube. When the loading operation is over, the male key of the lower outer tank tube is inserted into the key slot of the nut, and the screw is driven into rotation and is screwed into the nut from below. Following this, the upper inner press tube is rigidly connected to the nut, e.g., by threading onto the outer thread of the nut. The outer press tube is placed onto the inner plate tube, and the upper end of the inner plate tube is secured to the upper end of the outer plate tube, e.g., by means of a threaded fitting.

After the upper and lower parts of the press are assembled, the lead screw is activated for rotation in an appropriate direction for causing the nut to move downward. Since the nut is rigidly connected to the to the press plate tube, the entire press plate assembly is rigidly connected to the nut and is attached to the lead screw. Therefore, the press plate will move downward, i.e., in the direction of squeezing the grape. The liquid part of the must is squeezed out through the perforations of the press plate while the solids remain in the space between the lower surface of the press plate and the bottom of the basket. The stroke of the press plate is preferably limited by the limit switch that protects the apparatus from damage. The lowermost position of the press plate is therefore stopped when the liquid component is substantially squeezed out and the solids remain between the plate and the basket bottom. At this moment the press plate engages the locking means on the basket whereby the basket with the compressed solids is removed from the tank together with the press plate and the rest of the upper part of the apparatus. Thus, the skins will be removed with the press plate when the press plate is raised and removed from the tank. Following this, a fermentation process can be initiated with appropriate controls sugar content, etc., by means of known device such as a Brix meter, or the like. Temperature of the must in accordance with the fermentation process is controlled by means of the aforementioned Peltier cooling-heating unit. In the case of red wine production, the aforementioned fermentation begins first followed sequentially by pressing of the grapes.

### BRIEF DESCRIPTION OF THE DRAWINGS

FIG. 1 is a general three-dimensional view of the wine-making pressing and fermenting apparatus of the invention.

FIG. 2 is a schematic vertical cross-sectional view of the apparatus of the invention with lower arrangement of the drive unit.

FIG. 3 is a schematic vertical sectional view of the upper part of the apparatus of FIG. 2.

FIG. 4 is a schematic view of a cooling/heating system of the apparatus of the invention.

FIG. 5 is a fragmental sectional view that illustrates modification of the connection of the nut with the press tube.

FIG. 6 is a schematic view of another embodiment of the apparatus of the invention in which the drive motor and the lead screw have an overhead orientation.

FIG. 7A is a partial sectional view of a wine press according to another embodiment of the invention, where channeling means between the parts of the tank separated by the press plate are made in the form of grooves in the edges of the press plate.

FIG. 7b is a view similar to one shown in FIG. 7a with the difference that the press plate may slide inside the perforated basket.

FIG. 8A is a cross section along the line VIIIA-VIIIA of FIG. 7A.

FIG. 8B is a view similar to FIG. 8A except that channeling means between the parts of the tank separated by the press plate are made in the form of an annular gap between the edges of the press plate and the inner wall of the perforated basket.

FIG. 9 is a partial sectional view of a wine press of the embodiment where means for separation of liquid components of the must from the solid components of the must are made in the form of perforations in the bottom plate of the tank.

### DETAILED DESCRIPTION OF THE INVENTION

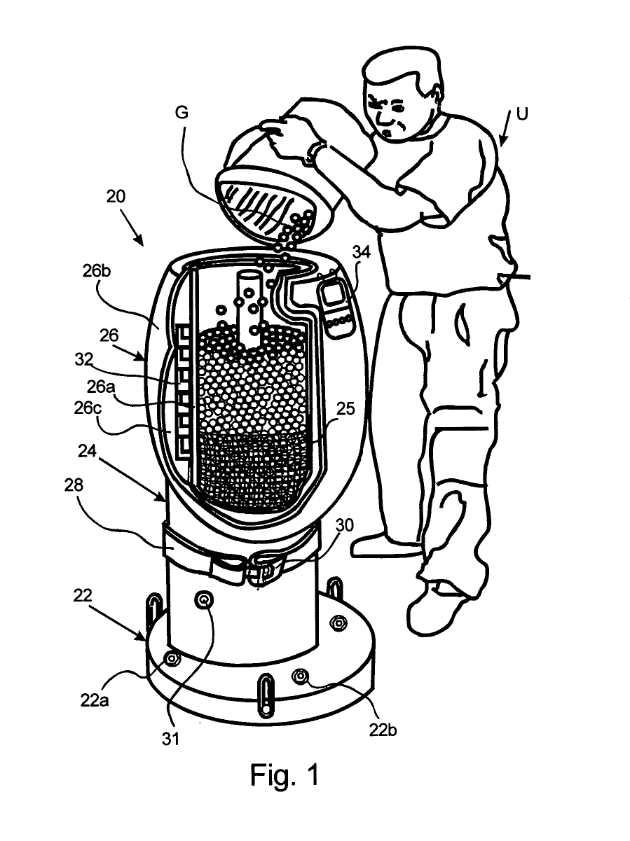

A general three-dimensional view of the wine-making pressing and fermenting apparatus is shown in FIG. 1, where reference numeral 20 designates the apparatus as a whole. In general, the apparatus consists of the following three main parts: a base plate 22, a hollow pedestal 24 supported by the base plate 22, and a compression-fermentation tank 26 supported by the hollow pedestal 24.

The base plate 22 may comprise a heavy metal casting that imparts to the apparatus 20 stability sufficient for normal operation of the below-described compression mechanism, or, if necessary, the base plate may be anchored to the floor by anchor bolts 22a, 22b, . . . . Reference numerals 22-1, 22-2, . . . designate eye bolts that can be used for handling the base plate.

The pedestal 24 can be made as a single piece with the base plate 22 and can be cast together with the base plate 24, welded thereto, or attached by bolts (not shown). It may also be sufficiently massive for adding to the weight of the base plate and thus to the stability of the apparatus. The pedestal 24 is hollow and the cavity of the pedestal can be used for locating various drive mechanisms, a cooling system pump, and other devices described below.

The compression-fermentation tank 26 (hereinafter referred to as “the tank 26”) has a wine-glass appearance and is supported by the hollow pedestal 24 to which the tank is rigidly attached. For example, the lower part of the tank 26 may have projections insertable into recesses (not shown) on the upper end face of the pedestal 24, and both engaged portions can be locked together, e.g., by a clamping belt 28 that is embraces and overlaps the interface area between the pedestal 24 and the tank 26 and is tightened by a clamping bolt 30.

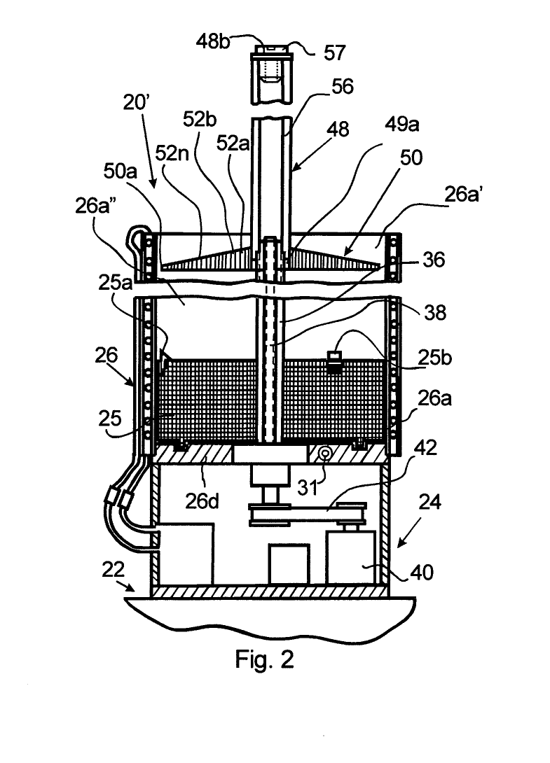

The tank 26 consists of a main cylindrical part 26a made of a stainless steel having a closed bottom (not shown in FIG. 1) and the open upper end and a thin wine-glass-shaped outer casing 26b that surrounds the main cylindrical part and forms a space 26c between the inner wall of the outer casing 26b and the outer wall of the main cylindrical part 26a. The outer casing 26b can be made from a material which is sufficiently strong and resistant to thermal deformations. Located in the space 26c between the casing 26 and the main cylindrical part 26a is a heating-cooling unit element 32 in the form of flat hollow belt helically wrapped around the main cylindrical part 26a for circulation of a cooling/heating medium the temperature of which is controlled by means of a cooling-heating unit, which is located in the hollow pedestal 24 and will be described later. If necessary, the hollow helical cooling/heating unit element may have a round cross-section and made from a tube, as shown in FIG. 2.

Reference numeral 34 designates a control console that may be conveniently located on the outer surface and at the upper end of the casing 26.

Thus, the apparatus 20 may have an attractive appearance resembling in its shape a big wine glass having a flat bottom plate the function of which is accomplished by a base plate 22, a cylindrical stem the function of which is fulfilled by the hollow pedestal 24, and a barrel shaped glass the function of which is fulfilled by the casing 26. The upper end of the tank 26 can be closed by a cover (not shown in FIG. 1). It is understood that the above-described shape of the apparatus is shown only as an example and that the external parts may have any other suitable configurations. It is also understood that the apparatus may have different dimensions for industrial and domestic applications, but in a model for domestic use of the type shown in FIG. 1, the height of the apparatus may be about 1 meter to 1.50 meter in order a user U could easily load the grape G and other components into the tank 26 while standing on the floor or ground where the apparatus is installed. In a model for industrial production, the tank may have any desired height and can be loaded with the use of auxiliary devices such as an overhead hopper, or the like, and include a jacketed stainless steel tank for temperature control (not shown).

Reference numeral 31 designates a drain valve for discharge of the liquid product, if necessary (FIGS. 1 and 2). Placed onto the bottom of the main cylindrical part 26a is a perforated basket 25 having an open upper side.

Having described the wine-making apparatus 20 and its external parts in general, let us now consider the main functional parts and mechanisms of the apparatus with reference to FIGS. 2 to 4.

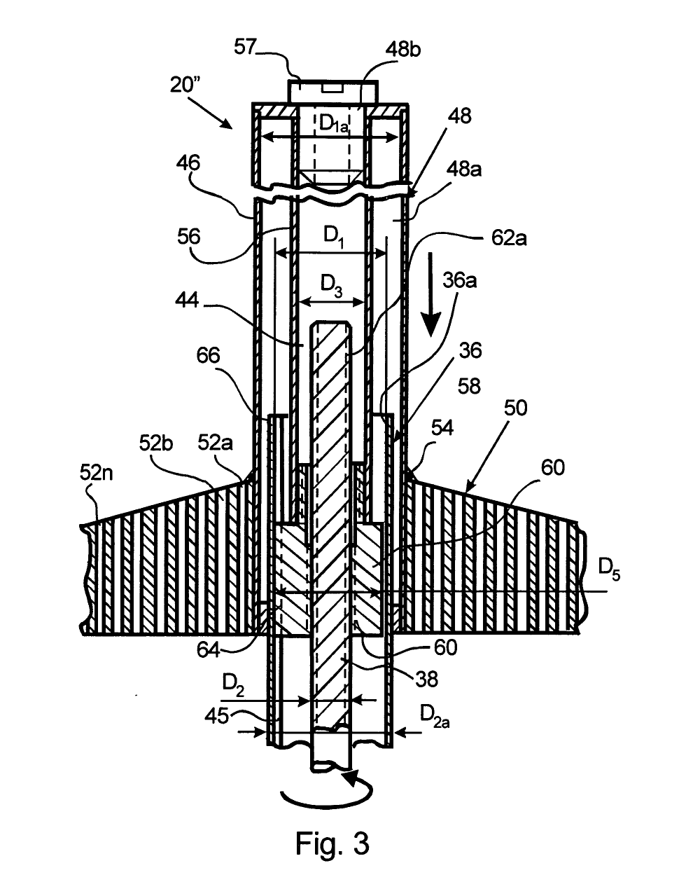

FIG. 2 is a schematic vertical sectional view of the lower part 20′ of the apparatus 20 wherein for the simplicity of the drawing the casing 26 is shown with the cylindrical shape instead of the wine-glass shape shown in FIG. 1. FIG. 3 is a schematic vertical sectional view of the upper part 20″ of the apparatus 20 which is shown on a larger scale than the lower part 20′ in FIG. 2 and which is placed from above onto the lower part for interaction of appropriate mechanisms of both parts.

Welded or removably attached to the central part of the tank bottom 26d (FIG. 2) is a lower inner vertical tank tube 36 (hereinafter referred to as a “tank tube 36”) with an open upper end 36a (FIG. 3). Inserted into the central opening of this tube 36 is a lead screw 38 (FIGS. 2 and 3) that is driven into rotation from an electric motor 40 (FIG. 2), preferably a DC motor, which is located inside the hollow pedestal portion 24 and is kinematically connected to the lead screw 38 directly or through an appropriate transmission 42 with a gear ration that may be required for increase of the torque on the lead screw. The inner diameter D₁ of the opening in the aforementioned tank tube 36 is greater than the outer diameter D₂ (FIG. 3) of the lead screw 38 so that an annular gap 44 is formed between the inner surface of this tube and the outer surface of the lead screw. The tank tube 36 has on its inner surface a vertical longitudinal key element 45, which may be, e.g., a male guide key projecting inwardly from the inner surface of the tank tube 36.

The upper part 20″ (FIG. 3) of the apparatus 20, which interacts with the above-described lower part 20′ and is removably connected therewith consists of an upper outer tank tube 48 (hereinafter referred to as “outer tank tube 48”) (FIG. 3) that can be telescopically fitted with its central opening 48a onto the outer surface of the aforementioned tank tube 36.

Attached to the lower end of the outer tank tube 48 is a press plate 50 (FIGS. 2 and 3) that has a shape and diameter suitable for insertion of the plate 50 into the compression-fermentation tank 26a (FIGS. 1 and 2). When the press plate 50 is inserted into the tank 26a, it divides the tank into a first space 26a′ above the press plate 50 and a second space 26a″ below the press plate 50. The first space 26a′ and the second space 26a″ are in communication via channeling means in the form of a plurality of through perforations 52a, 52b, . . . 52n (FIG. 3) for passing the juice squeezed out from the grape. In other words the perforations 52a, 52b . . . 52n function as means for separating liquid components of the must from solid components of the must. The press plate 50 can be welded, as shown by reference numeral 54 in FIG. 3, to the outer surface on the lower end of the outer press tube 48 or can be removably attached thereto. The lower end 49a (FIG. 2) of the tank tube 48 is open, while the upper end is closed with the bottom wall 48b (FIGS. 2 and 3) that removably supports an inner press tube 56, e.g., by means of a threaded fitting 57, so that the inner press tube 56 extends downward from the aforementioned bottom wall 48b and is arranged inside the upper tube 48 concentrically to its inner wall. The lower end of the press plate tube 56 has an inner thread 58 (FIG. 3), which is engaged with an outer thread (not shown) of a nut 60 for securing the nut 60 to the press plate tube 56. Alternatively, the nut can be press-fitted into the press plate tube or attached thereto by another appropriate method that provides rigid connection between both parts. The nut 60 has an inner thread 60a for engagement with the thread 62a (FIG. 3) of a lead screw 38 (FIGS. 2 and 3).

The aforementioned outer diameter D₂ (FIG. 3) of the lead screw 38, which is located in the lower 20′ part (FIG. 2) of the apparatus 20, should be smaller than the inner diameter D₃ (FIG. 3) of the inner press plate tube 56 so that, while engaging the nut, the lead screw 38 could without obstacles penetrate the central opening of the inner press plate tube 56. It is recommended that the thread that connects the nut 60 to the inner press plate tube 56 and the thread of the nut that engages the lead screw 38 have opposite directions.

In order to prevent rotation of the nut 60 and impart to it only a linear motion due to engagement with the lead screw 38, the outer surface of the nut has a key slot 64 (FIG. 3) for engagement with the aforementioned male guide key 45 of the tank tube 36.

In order to be able to fit the entire upper part 20″ of the apparatus on the lower part 20′ thereof, the wall thickness of the tank tube 36 should be smaller than the annular gap 66 (FIG. 3) between the outer surface of the nut 60 and the inner surface of the outer press tube 48, i.e., the inner diameter D₁ₐ of the press tube 48 should be greater than the outer diameter D₂ₐ of the tank tube 36 and than the outer dimension D₅ of the nut 60.

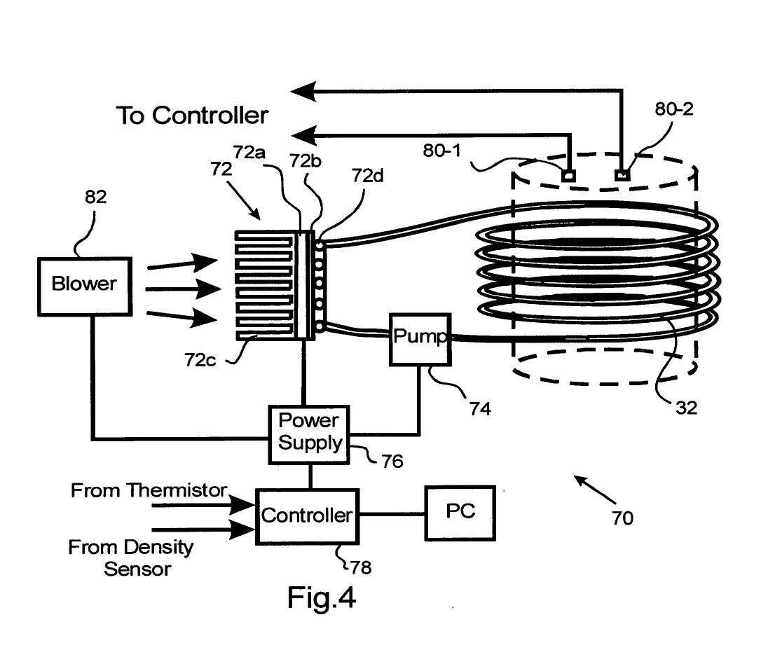

Located between the main cylindrical part 26a and the casing 26b of the barrel portion 26 is a heating-cooling unit element 32 in the form of flat hollow belt (FIG. 1) or in the form of a tube (FIG. 2) helically wrapped around the main cylindrical part 26a for circulation of a cooling/heating medium the temperature of which is controlled by means of a cooling-heating unit 70 schematically shown in FIG. 4. The aforementioned basket 25 (FIG. 1 and FIG. 2), which is placed onto the bottom of the main cylindrical part 26a, has locking pawls, preferably three pawls, only two of which 25a and 25b are shown in FIG. 2. These pawls are intended for engaging the peripheral edge 50a of the press plate 50 so that when the press plate 50 reaches its lowermost position in the main cylindrical part 26a, i.e., at the end of the compression cycle, the basket 25, which contains only the compressed solids of the grape skin and the like, is locked to the press plate 50 and can be removed with the residual solid content of the must from the main cylindrical part 26a by reversing the motor 40 and hence the screw 38.

Apart from the aforementioned heating/cooling unit element 32, the heating/cooling system 70 contains a heat-exchange unit 72, a pump 74 for pumping the heat-exchanging medium, e.g., water, through the heating-cooling unit element 32, a power supply 76, a controller 78, and various sensors for controlling parameter of the must, such as a sugar content, temperature, etc. These sensors are conventionally shown in FIG. 4 by reference numerals 80-1 and 80-2. The description of these sensors is beyond the scope of the present invention. It should be noted, however, that the sensors 80-1′ and 80-2 are connected to the controller 78. The latter can be connected to a computer PC or another processing unit.

The heat exchanging unit 72 consists of a Peltier element 72a, one side of which is heat-exchanging contact with a thermoconductive plate 72b, e.g., a copper plate while the other side thereof is in heat-exchanging contact with a heat-radiating element, such as a heat sink 72c. The copper plate 72b, in turn, is in a heat-exchanging portion of the aforementioned heating-cooling unit element 32, which in the area of contact with the copper plate is made with a serpentine shape. If necessary, the efficiency of removal of heat, the heat sink 72c can be provided with a blower 82 (FIG. 4).

It should be noted that the wine-making process may require not only cooling of the must but heating as well. Therefore the heating/cooling system 70 Is reversible, and heating can be achieved instead of cooling by changing the direction of DC current flowing through the Peltier element, so that the heating side and the cooling side change their positions to the opposite. The processing unit PC can be incorporated into the control console 34 (FIG. 1) or may be located remotely in a control room. However, other means of cooling and heating could be used such as a compressor/heat exchanger for cooling and a resistive element for heating.

The device operates as follows. First, the upper part 20″ that consists of press plate 50 with outer press tube 48, the nut 60, and the inner press plate tube 56 is removed from the apparatus, and the grape G (FIG. 1), if necessary, with other ingredients is loaded from the above into the tank 26a. The loaded charge should not exceed the level of the open upper end of the tank tube 36. When the loading operation is over, the male key 45 of the tank tube 36 is inserted into the key slot 64 of the nut 60, and the screw 38 is driven into rotation and is screwed into the nut 60 from below. Following this, the inner press tube 56 is rigidly connected to the nut 60, e.g., by threading onto the outer thread of the nut 60. The outer press tube 48 is placed onto the plate tube 36, and the upper end of the inner plate tube 56 is secured to the upper end of the outer plate tube 48, e.g., by means of a threaded fitting 57.

After the upper and lower parts 20″ and 20′ of the press 20 are assembled, the lead screw 38 is activated for rotation in an appropriate direction for causing the nut 60 to move downward. Since the nut 60 is rigidly connected to the inner press plate tube 56, the latter is rigidly connected to the outer press tube 48, and the outer press tube 48 is rigidly connected to the press plate 50, the latter will move downward, i.e., in the direction of squeezing the grape G. The liquid part of the must is squeezed out through the perforations 52a, 52b, . . . 52n of the press plate 50 while the solids remain in the space between the lower surface of the press plate 50 and the bottom of the basket 25. The stroke of the press plate is limited by the limit switch (not shown) that protects the apparatus from damage. The lowermost position of the press plate 50 is adjusted so that the plate stops when the entire liquid component is squeezed out and only the solids remain between the plate 50 and the basket bottom. At this moment the press plate engages the locking pawls 25a, 25b . . . on the basket 25 whereby the basket 25 with the compressed solids is removed from the main cylindrical part 26a together with the press plate 50 and the rest of the upper part 20″ of the apparatus 20.

Following this, for white wine, a fermentation process can be initiated with appropriate controls of sugar content, etc., by means of the sensors 80-1, 80-2, etc., such as a known Brix meter, etc. Temperature of the must in accordance with the fermentation process is controlled by means of the aforementioned cooling-heating system 70 shown in FIG. 4. For red wines, the fermentation begins before pressing.

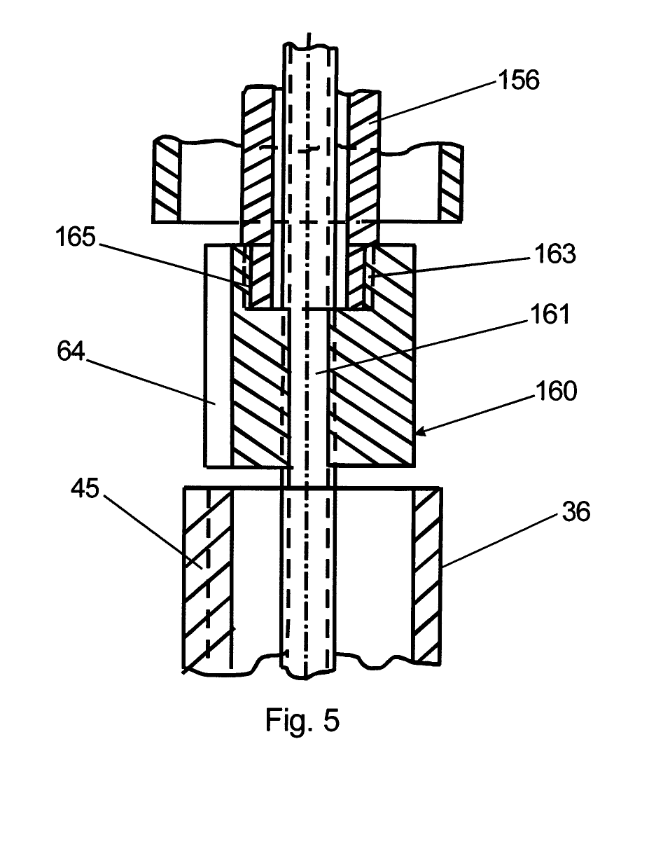

FIG. 5 is a fragmental sectional view that illustrates another method for connecting the nut to the inner press tube. According to this method, a nut 160 is provided with two inner threads, i.e., a first thread 161 for engagement with the lead screw 38 and a second thread 163 for engagement with an outer thread 165 formed on the lower end of the inner press tube 156. Reference numeral 45 designates the male key on the inner surface of the tank tube 36, reference numeral 64 designates the key slot on the outer surface of the nut 160, and reference numeral 48 designates the outer press tube. The rest of the apparatus may be the same as in the previous embodiment.

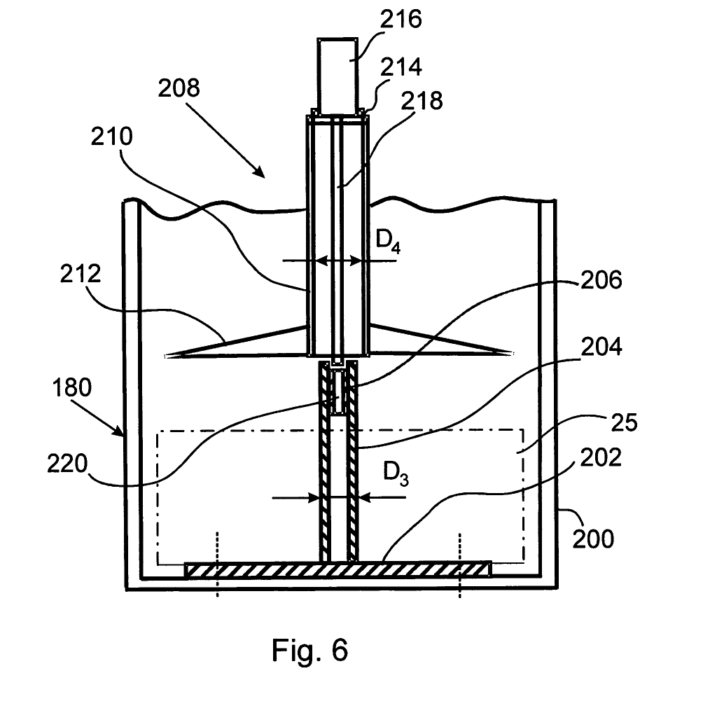

FIG. 6 is a schematic view of another embodiment of the apparatus of the invention in which the drive motor and the lead screw have an overhead orientation. The lower part 180 of the apparatus consists of a tank 200, a bottom plate 202 that rigidly supports a tank tube 204 vertically arranged in the center of the tank 200. Inserted into the upper end of the tank tube 204 is a nut 206 which is rigidly fixed in the tank tube, e.g., by means of an outer thread on the nut and an inner thread in the tube (not shown).

The upper part 208 of the apparatus consists of a press tube 210 that support a press plate 212 rigidly attached to the outer periphery of the press tube 210 on its open lower end. The upper end of the press tube 210 is closed by a cover 214 that supports a drive motor 216, e.g., a DC motor. The output shaft of this motor is directly connected to a lead screw 218 engageable with the inner thread 220 of the nut 206. The outer diameter D₃ of the tank tube 204 is smaller than the inner diameter D₄ of the press tube 210. It is understood that the same basket 25, which is shown in FIG. 2, can be placed onto the bottom plate 202 of the tank 200.

An advantage of the embodiment shown in FIG. 6 is simplicity of the construction. Another advantage is a reduced need in cleaning since the tank tube 204 is closed by the nut which protects the interior of the tank tube from penetration of solid and liquid substances.

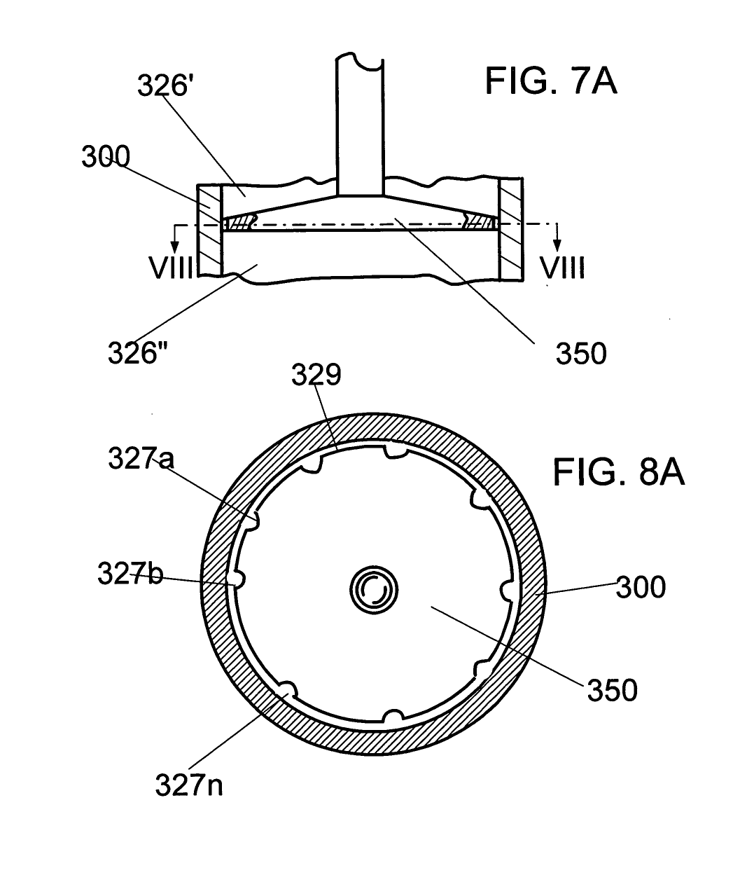

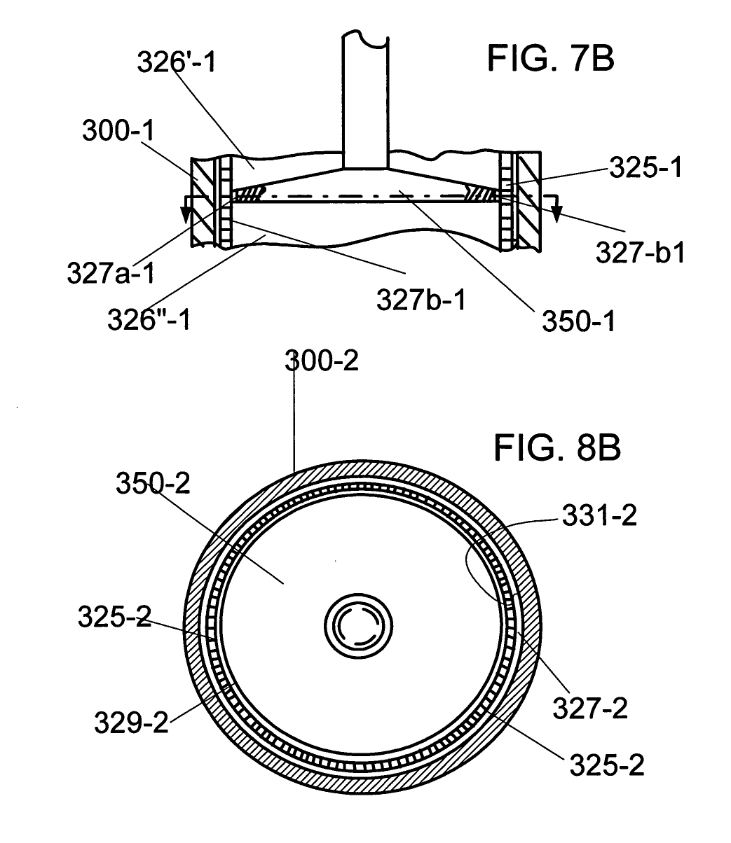

FIG. 7A is a partial sectional view of a wine press according to another embodiment of the invention, and FIG. 8A is a cross section along the line VIIIA-VIIIA. These drawings show that means for separation of the liquid components of the must from solid components of the must, i.e., channeling means between the space 326′ of the tank 300 above the press plate 350 and the space 326″ below the press plate 350, comprise a plurality of grooves or channels 327a, 327b, . . . 327n formed on the peripheral edge 329 of the press plate 350. In this embodiment, the edge 329 of the press plate 350 should have a sliding fit relative to the inner surface 331 of the tank 300. The perforated basket 25 cannot be used in this embodiment.

FIG. 7B is a view similar to one shown in FIG. 7A with the difference that a basket 325-1 is inserted into the tank 300-1. The basket 325-1 may comprise a thin-walled container with smooth inner and outer walls made from stainless steel. In this embodiment, the press plate 350-1 is slidingly fitted into the basket instead of the tank 300-1. The purpose and use of the perforated basket 325-1 is the same as that of the basket 25 in the previously described embodiment. Reference numerals 327a-1 and 327-1 designate grooves of the same type as the grooves 327a, 327b, . . . shown in FIG. 8A.

FIG. 8B is a view similar to one shown in FIG. 8A except that a basket 325-2 of the type shown in FIG. 7B is used and that an annular gap 327-2 formed between the peripheral edge 328-2 and the smooth inner surface of the perforate basket 325-2 is used as means for separation of the liquid components of the must from solid components of the must, i.e., channeling means between the space of the tank 300-2 above the press plate 350-2 and the space below the press plate 350-2,

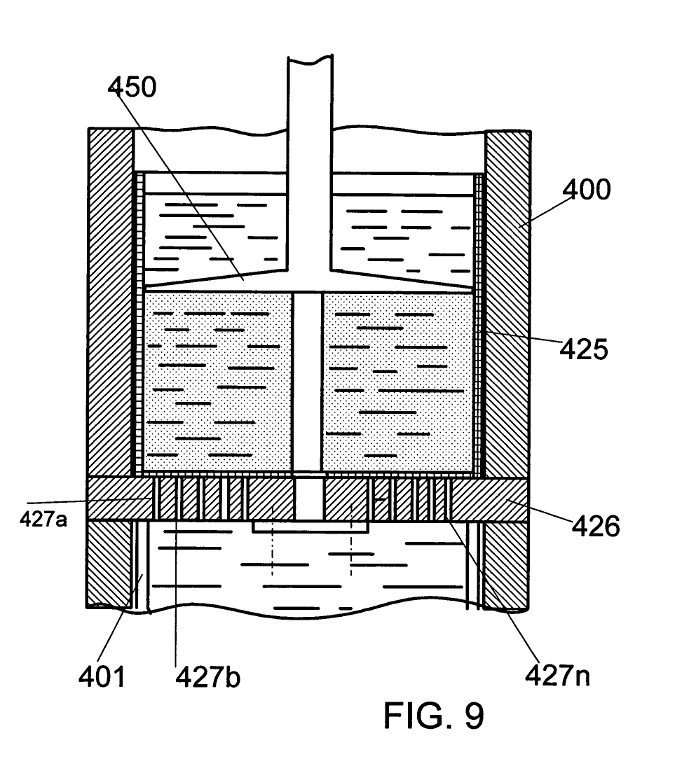

FIG. 9 is a partial sectional view of a wine press of the invention according to the embodiment where means for separation of liquid components of the must from the solid components of the must are made in the form of perforations 427a, 427b, . . . 527n in the bottom plate 426 of the tank 400. Reference numeral 425 designates a basket of the same type as basket 325-2 mentioned and described in the previous embodiment. A container 401 for collection of the liquid component squeezed out by the press plate 450 from the must contained in the space 426″ of the basket 425 under the press plate 450 is placed under the bottom plate beneath the perforations 427a, 427b, . . . 527n.

Thus, it has been shown that the invention provides a wine press the construction of which is suitable for domestic and commercial use, which is simple and compact in construction, simple in maintenance, allows crushing, pressing, and fermenting of the wine making ingredients in a single tank, uses electric drive instead of hydraulic or pneumatic drives, occupies a reduced floor space, has an efficient cooling/heating system that makes the press suitable for making wines and beverages of different types with versatility of fermentation processes, and is equipped with a device for efficient and convenient removal of the grape skin residue.

The invention has been shown and described with reference to specific embodiments, which should be construed only as examples and do not limit the scope of practical applications of the invention. Therefore any changes and modifications in technological processes, constructions, materials, shapes, and their components are possible, provided these changes and modifications do not depart from the scope of the patent claims. For example, the tubes may have a rectangular, square, oval, or any other cross section so that there will be no need in providing a male-key and a key-slot connection between the tank tube and the nut. Splines can be used instead of key. The tank itself and the press plate may have any other regular or irregular cross sections. An AC motor can be used instead of a DC motor. Transfer of torque to the screw can be made directly from the output shaft of the motor or through a gear reducer, chain transmission, or any other transmission with vertical or horizontal arrangement of the motor. Cooling of the tank can be carried out with the use of a water jacket, and by using a cooling unit other than a Peltier-type cooling unit. The press can be used with a basket and without a basket. The outer casing of the press may have a cylindrical, rectangular, or any other suitable shape.

1. A wine-making press comprising:
a compression-fermentation tank having a closed bottom and an open top;
a first tube member vertically arranged in said compression-fermentation tank, said first tube member having an inner diameter, an outer diameter, an upper end which is open, and a lower end which is supported by said closed bottom of said compression-fermentation tank, said compression-fermentation tank having an inner surface;
a second tube member, which has a lower end open towards the open end of said first tube member, an inner diameter, an outer diameter, and a closed upper end, the inner diameter of the second tube member being greater than the outer diameter of said first tube member;
a press plate rigidly connected to said second tube member, said press plate, when inserted into said compression-fermentation tank, dividing said compression-fermentation tank into a first space above said press plate and a second space below said press plate, said first space and said second space being in communication via channeling means, said press plate having an outer edge;
a nut rigidly connected with one of said first tube member or said second tube member, said nut having an inner thread and an outer dimension in a cross section of said first tube;
a lead screw engageable with said nut and located in the other of said first tube member or said second tube member; and
a drive motor for rotating said lead screw.

2. The wine-making press according to claim 1, wherein said drive motor is located under said compression-fermentation tank, said second tube contains a third tube member having a lower end which is open and an upper end which is attached to said closed upper end of the second tube member, said third tube member having an outer diameter smaller than said inner diameter of said first tube member so that a gap is formed between the inner surface of the first tube member and the outer surface of the third tube member, the inner diameter of the first tube member being greater than said outer dimensions of the nut for unobstructed passage of the nut through said first tubular member; said nut being inserted into said open end of the third tube member and being secured to the third tube member nut securing means so that when the lead screw engages said inner thread of the nut the third tube member, the second tube member, and the press plate move relative to the bottom of said compression-fermentation tank.

3. The wine-making press of claim 2, wherein said channeling means are selected from the group consisting of a plurality of through perforations formed in the press plate, an annular gap between the outer edge of said press plate and an inner wall of said compression-fermentation tank, and perforations in the bottom of said compression-fermentation tank.

4. The wine-making press of claim 2, further comprising a perforated basket that has a cross-sectional dimension in the plane across said compression-fermentation tank, which is smaller than said the cross-section of said compression-fermentation tank but greater than a cross-section of said press plate so that said press plate can enter said basket when said basket is installed on the bottom of said compression-fermentation tank, said basket having locking means capable of locking said basket to said press plate when said press plate is inserted into said basket to a predetermined position.

5. The wine-making press of claim 4, wherein said basket has an inner wall, said channeling means are selected from the group consisting of a plurality of through perforations formed in the press plate, an annular gap between the outer edge of said press plate and the inner wall of said perforated basket, and perforations in the bottom of said compression-fermentation tank under said perforated basket.

6. The wine-making press of claim 3, further comprising means for preventing rotation of said nut relative to said first tubular member when the lead screw engages the nut.

7. The wine-making press of claim 6, wherein said means for preventing rotation of said nut relative to said first tubular member is a key in one of the nut or first tubular member and a key slot engaging said key and formed in other one of the nut or first tubular member.

8. The wine-making press of claim 4, further comprising means for preventing rotation of said nut relative to said first tubular member when the lead screw engages the nut.

9. The wine-making press of claim 8, wherein said means for preventing rotation of said nut relative to said first tubular member is a key in one of the nut or first tubular member and a key slot engaging with said key and formed in other one of the nut or first tubular member.

10. The wine-making press of claim 6, further comprising means for preventing rotation of said nut relative to said first tubular member when the lead screw engages the nut.

11. The wine-making press of claim 10, wherein said means for preventing rotation of said nut relative to said first tubular member is a key in one of the nut or first tubular member and a key slot engaging with said key and formed in other one of the nut or first tubular member.

12. The wine-making press according to claim 2, wherein said nut securing means comprises an outer thread on said nut and an inner thread in said open end of said third tubular member.

13. The wine-making press according to claim 4, wherein said nut securing means comprises an outer thread on said nut and an inner thread in said open end of said third tubular member.

14. The wine-making press according to claim 7, wherein said nut securing means comprises an outer thread on said nut and an inner thread in said open end of said third tubular member.

15. The wine-making press according to claim 9, wherein said nut securing means comprises an outer thread on said nut and an inner thread in said open end of said third tubular member.

16. The wine-making press according to claim 2, wherein said nut securing means comprises a second inner thread in the nut on the side of the nut facing said open end of said third tubular member and an outer thread on said open end of said third tubular member engageable with the second inner thread of the nut, said second inner thread having a diameter greater than said inner thread engageable with the lead screw.

17. The wine-making press according to claim 4, wherein said nut securing means comprises a second inner thread in the nut on the side of the nut facing said open end of said third tubular member and an outer thread on said open end of said third tubular member engageable with the second inner thread of the nut, said second inner thread having a diameter greater than said inner thread engageable with the lead screw.

18. The wine-making press according to claim 7, wherein said nut securing means comprises a second inner thread in the nut on the side of the nut facing said open end of said third tubular member and an outer thread on said open end of said third tubular member engageable with the second inner thread of the nut, said second inner thread having a diameter greater than said inner thread engageable with the lead screw.

19. The wine-making press according to claim 9, wherein said nut securing means comprises a second inner thread in the nut on the side of the nut facing said open end of said third tubular member and an outer thread on said open end of said third tubular member engageable with the second inner thread of the nut, said second inner thread having a diameter greater than said inner thread engageable with the lead screw.

20. The wine-making press according to claim 1, wherein said drive motor is located on the closed upper end of the second tubular member and is kinematically connected to said lead screw; said lead screw being located in said second tubular member, said nut being inserted into said open end of the first tubular member and secured to said first tubular member so that when said lead screw engages the nut from above said first tubular member, the second tubular member together with the drive motor, lead screw, and press plate move integrally relative to the bottom of said compression-fermentation tank.

21. The wine-making press according to claim 2, wherein said drive motor is located on the closed upper end of the second tubular member and is kinematically connected to said lead screw; said lead screw being located in said second tubular member, said nut being inserted into said open end of the first tubular member and secured to said first tubular member so that when said lead screw engages the nut from above said first tubular member, the second tubular member together with the drive motor, lead screw, and press plate move integrally relative to the bottom of said compression-fermentation tank.

22. The wine-making press according to claim 4, wherein said drive motor is located on the closed upper end of the second tubular member and is kinematically connected to said lead screw; said lead screw being located in said second tubular member, said nut being inserted into said open end of the first tubular member and secured to said first tubular member so that when said lead screw engages the nut from above said first tubular member, the second tubular member together with the drive motor, lead screw, and press plate move integrally relative to the bottom of said compression-fermentation tank.

23. The wine-making press according to claim 1, further comprising a cooling/heating system for cooling/heating a content of said compression-fermentation tank, said cooling/heating system comprising a cooling/heating member in a heat-exchange relationship with said compression-fermentation tank via a cooling/heating medium flowing through said cooling/heating member and cooling/heating unit for cooling/heating said cooling/heating medium.

24. The wine-making press according to claim 23, wherein said cooling/heating unit is a Peltier-type cooling/heating unit.

25. The wine-making press according to claim 4, wherein said cooling/heating unit is a Peltier-type cooling/heating unit.

26. The wine-making press according to claim 22, wherein said cooling/heating unit is a Peltier-type cooling/heating unit.

27. The wine-making press of claim 5, further comprising means for preventing rotation of said nut relative to said first tubular member when the lead screw engages the nut.

28. The wine-making press of claim 27, wherein said means for preventing rotation of said nut relative to said first tubular member is a key in one of the nut or first tubular member and a key slot engaging said key and formed in other one of the nut or first tubular member.

29. The wine-making press according to claim 5, further comprising a cooling/heating system for cooling/heating a content of said compression-fermentation tank, said cooling/heating system comprising a cooling/heating member in a heat-exchange relationship with said compression-fermentation tank via a cooling/heating medium flowing through said cooling/heating member and cooling/heating unit for cooling/heating said cooling/heating medium.

30. The wine-making press according to claim 29, wherein said cooling/heating unit is a Peltier-type cooling/heating unit.
